(19) United States
(12) Patent Application Publication
(10) Pub. No.: US 2014/0172369 A1
(43) Pub. Date: Jun. 19, 2014

(54) COMPUTER-READABLE RECORDING MEDIUM, ABNORMALITY CAUSE ESTIMATING APPARATUS, AND ABNORMALITY CAUSE ESTIMATING METHOD

(71) Applicant: FUJITSU LIMITED, Kawasaki-shi (JP)

(72) Inventors: Hideya IKEDA, Urayasu (JP); Nobuhiko Fukui, Bunkyo (JP); Minoru Yamamoto, Urayasu (JP)

(73) Assignee: FUJITSU LIMITED, Kawasaki-shi (JP)

(21) Appl. No.: 14/045,247

(22) Filed: Oct. 3, 2013

(30) Foreign Application Priority Data
Dec. 19, 2012 (JP) 2012-277427

(51) Int. Cl. G06F 11/22

(52) U.S. Cl. CPC G06F 11/22
USPC 702/183

(57) ABSTRACT

A computer-readable recording medium stores therein an abnormality cause estimating program causing a computer to execute a process. The process includes acquiring load information of a system; determining whether or not the system indicates abnormality based on the load information, and specifying a first function group which includes one or a plurality of functions executed by the system when the determination indicates that the system indicates the abnormality and specifying a second function group which includes one or a plurality of functions executed by the system when the determination indicates that the system does not indicate abnormality; and outputting information of a function which is not included in the second function group among the functions included in the first function group.

### CROSS-REFERENCE TO RELATED APPLICATION

This application is based upon and claims the benefit of priority of the prior Japanese Patent Application No. 2012-277427, filed on Dec. 19, 2012, the entire contents of which are incorporated herein by reference.

### FIELD

The embodiment discussed herein is directed to an abnormality cause estimating program, an abnormality cause estimating apparatus, and an abnormality cause estimating method.

### BACKGROUND

Conventionally, there is software which acquires details of an operation log of an external application. This software implements processing of acquiring logs in each method upon compiling of a source code of an application or before execution of an application according to an aspect-oriented technique. Further, this software analyzes an input and an output of a method to store as log information.

Furthermore, there is also a technique of estimating a cause that abnormality occurs in a system which executes an external application. For example, according to this technique, a function such as a user operation at a time at which abnormality occurs in a system is acquired from log information, and the acquired function is estimated as a cause that abnormality occurs in the system.
Patent Document 1: Japanese Laid-open Patent Publication No. 2010-231568
Patent Document 2: Japanese Laid-open Patent Publication No. 2006-099249
Patent Document 3: Japanese Laid-open Patent Publication No. 2005-141459
Patent Document 4: Japanese Laid-open Patent Publication No. 2009-169623
Patent Document 5: Japanese Laid-open Patent Publication No. 2012-094046

However, in case of an online system which executes a plurality of functions in parallel, it is difficult to specify a function which causes occurrence of abnormality in this online system.

For example, the online system receives an input of a plurality of operations from a plurality of users, and executes functions matching these inputs in parallel. In this case, the online system executes functions which cause abnormality and functions which do not cause abnormality in parallel. A function group executed upon occurrence of abnormality includes functions which cause abnormality and functions which do not cause abnormality, and therefore an operator has difficulty in specifying the functions which cause abnormality.

### SUMMARY

According to an aspect of an embodiment, a computer-readable recording medium stores therein an abnormality cause estimating program causing a computer to execute a process. The process includes acquiring load information of a system; determining whether or not the system indicates abnormality based on the load information, and specifying a first function group which includes one or a plurality of functions executed by the system when the determination indicates that the system indicates the abnormality and specifying a second function group which includes one or a plurality of functions executed by the system when the determination indicates that the system does not indicate abnormality; and outputting information of a function which is not included in the second function group among the functions included in the first function group.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of a configuration of a system to which a center which is an example of an abnormality cause estimating apparatus according to an embodiment is applied;

FIG. 2 is a view illustrating an example of a data configuration of overview data;

FIG. 3 is a view illustrating an example of a data configuration of incident data;

FIG. 4 is a view illustrating an example of a data configuration of a first DB;

FIG. 5 is a view illustrating an example of a data configuration of a second DB;

FIG. 6 is a view illustrating an example of a data configuration of a third DB;

FIG. 7 is a view illustrating an example of a data configuration of a fourth DB;

FIG. 8 is a view for explaining an example of processing executed by the center according to the embodiment;

FIG. 9 is a view for explaining an example of processing executed by the center according to the embodiment;

FIG. 10 is a view for explaining an example of processing executed by the center according to the embodiment;

FIG. 11 is a view for explaining an example of processing executed by the center according to the embodiment;

FIG. 12 is a view for explaining an example of processing executed by the center according to the embodiment;

FIG. 13 is a view for explaining an example of processing executed by the center according to the embodiment;

FIG. 14 is a flowchart illustrating process of generation processing according to the embodiment;

FIG. 15 is a flowchart illustrating process of abnormality cause estimation processing according to the embodiment;

FIG. 16 is a view for explaining an example of processing executed by a center according to Modified Example; and

FIG. 17 is a view illustrating a computer which executes an abnormality cause estimating program.

### DESCRIPTION OF EMBODIMENTS

Preferred embodiments of the present invention will be explained with reference to accompanying drawings. In addition, the embodiment by no means limits the disclosed technique.

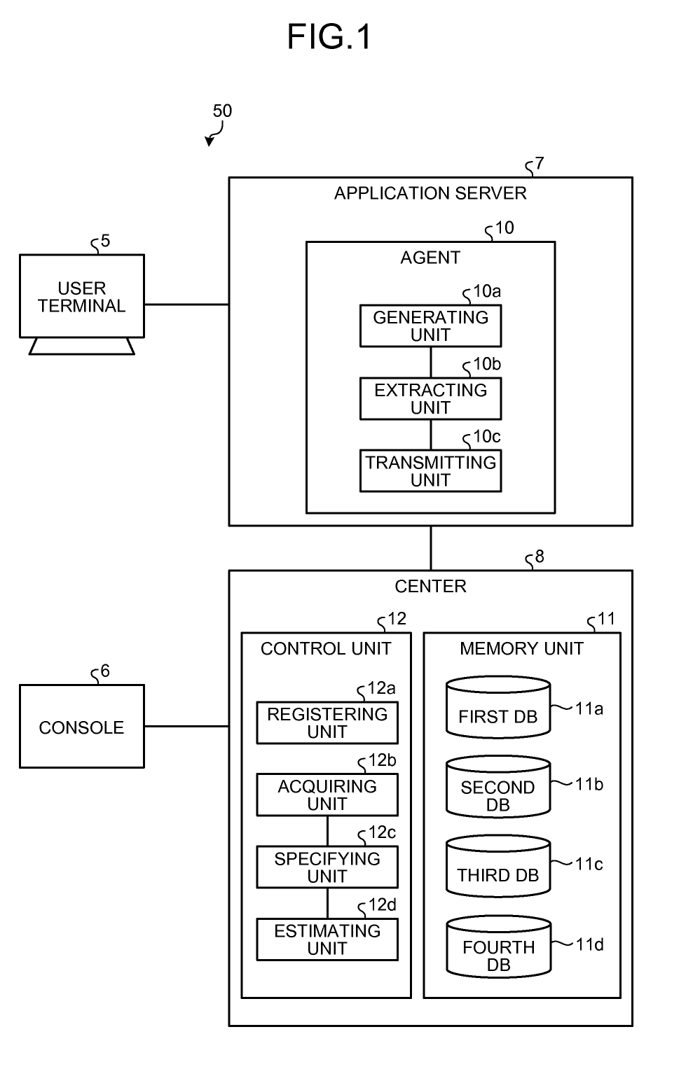

An abnormality cause estimating apparatus according to the embodiment will be described. FIG. 1 is a view illustrating an example of a configuration of a system to which a center which is an example of the abnormality cause estimating apparatus according to the embodiment is applied. As illustrated in FIG. 1, a system 50 has a user terminal 5, a console 6, an application server 7 and a center 8.

The user terminal 5 requests the application server 7 to execute an application, and acquires an execution result of the application from the application server 7. For example, the user terminal 5 transmits a command of executing an application specified by a user, to the application server 7, and acquires an execution result from the application server 7. In addition, the number of user terminals 5 is not limited to one and may be plural.

The console 6 is a terminal which requests the center 8 to perform various processing. For example, the console 6 receives an operation from a system user or an administrator, and receives a command to execute abnormality cause estimation processing described below. Further, the console 6 transmits the received command to the center 8. By this means, the center 8 executes abnormality cause estimation processing. Further, when receiving a screen transmitted from the center 8, the console 6 displays the received screen on a display apparatus which is not illustrated.

The application server 7 executes an application. Further, the application server 7 has an agent 10 which is set by an aspect-oriented technique and which acquires logs. The agent 10 has a generating unit 10a, an extracting unit 10b and a transmitting unit 10c.

The generating unit 10a generates overview data. For example, at predetermined time intervals, the generating unit 10a acquires load information such as a memory use rate and a CPU (Central Processing Unit) use rate of the application server 7 which executes applications. Further, at predetermined time intervals, the generating unit 10a acquires information of a button operated by the user among buttons included in the screen displayed by the application. An example will be described below where the generating unit 10a acquires load information including an average value of the memory use rate and an average value of the CPU use rate of the application server 7 in a past one minute per minute. Further, a case will be described below where the generating unit 10a acquires all pieces of information of buttons operated by the user in the past one minute per minute.

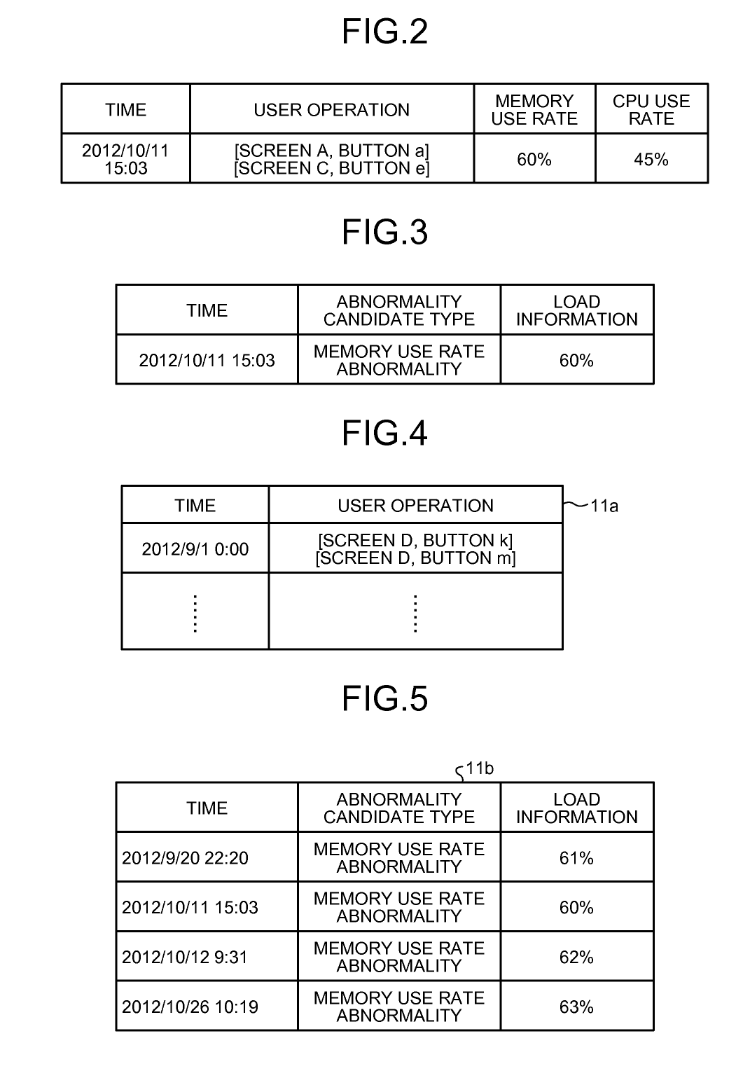

Furthermore, the generating unit 10a generates overview data obtained by associating acquired various pieces of information and a time per minute. FIG. 2 is a view illustrating an example of a data configuration of overview data. The overview data illustrated in an example in FIG. 2 includes items of “time”, “user operation”, “memory use rate” and “CPU use rate”. In the “time” item, a time to generate overview data is registered. In the “user operation” item, an identifier of a button operated by the user and an identifier of the screen which includes this button are registered. In the following description, a combination of a button identifier and a screen identifier is referred to as a user operation identifier. In the “memory use rate” item, an average value of a memory use rate of the application server 7 is registered. In the “CPU use rate” item, an average value of a CPU use rate of the application server 7 is registered.

The overview data illustrated in the example in FIG. 2 indicates overview data generated at 15:03 on Oct. 11, 2012. Further, the overview data illustrated in the example in FIG. 2 indicates that the user operates the following button among the buttons included in the screen indicated by a screen identifier “A” from 15:02 on Oct. 11, 2012 to 15:03 on Oct. 11, 2012. That is, the overview data illustrated in the example in FIG. 2 indicates that the button indicated by a button identifier “a” is operated. Further, the overview data illustrated in the example in FIG. 2 indicates that the user operates a following button among the buttons included in the screen indicated by a screen identifier “C” from 15:02 on Oct. 11, 2012 to 15:03 on Oct. 11, 2012. That is, the overview data illustrated in the example in FIG. 2 indicates that the button indicated by a button identifier “e” is operated. Further, the overview data illustrated in the example in FIG. 2 indicates that the average value of the memory use rate of the application server 7 from 15:02 on Oct. 11, 2012 to 15:03 on Oct. 11, 2012 is “60%”. Furthermore, the overview data illustrated in the example in FIG. 2 indicates that the average value of the CPU use rate of the application server 7 from 15:02 on Oct. 11, 2012 to 15:03 on Oct. 11, 2012 is “45%”.

Back to explanation of FIG. 1, the extracting unit 10b extracts overview data which indicates a predetermined event among the generated overview data every time overview data is generated. For example, the extracting unit 10b extracts overview data the memory use rate average value of which is registered in the “memory use rate” item and which is a predetermined threshold (for example, 50%) or more. Further, the extracting unit 10b extracts overview data the CPU use rate average value of which is registered in the “CPU use rate” item and which is a predetermined threshold (for example, 60%) or more. Thus, the extracting unit 10b extracts overview data indicating that abnormality is highly likely to occur in the application server 7. Subsequently, the extracting unit 10b generates incident data including a time registered in the “time” item of the extracted overview data, an abnormality candidate type and load information. When, for example, extracting overview data the memory use rate average value of which is registered in the “memory use rate” item and which is a predetermined threshold or more, the extracting unit 10b performs the following processing. That is, the extracting unit 10b generates incident data including a time registered in the “time” item of the extracted overview data, “memory use rate abnormality” and load information registered in the “memory use rate” item of the extracted overview data. Meanwhile, “memory use rate abnormality” indicates that “memory use rate” is an abnormality candidate. When extracting overview data the CPU use rate average value of which is registered in the “CPU use rate” item and which is a predetermined threshold or more, the extracting unit 10b performs the following processing. That is, the extracting unit 10b generates incident data including a time registered in the “time” item of the extracted overview data, “CPU use rate abnormality” and load information registered in the “memory use rate” item of the extracted overview data. Meanwhile, “CPU use rate abnormality” indicates that “CPU use rate” is an abnormality candidate. FIG. 3 is a view illustrating an example of a data configuration of incident data. The incident data illustrated in an example in FIG. 3 includes items of “time”, “abnormality candidate type” and “load information”. In the example illustrated in FIG. 3, in the “time” item, the time registered in the “time” item of overview data is registered. Further, in the “abnormality candidate type” item, above “memory use rate abnormality” or “CPU use rate abnormality” is registered. Furthermore, in the “load information” item, load information registered in the “memory use rate” or “CPU use rate” item of overview data associated with “memory use rate abnormality” or “CPU use rate abnormality”. Incident data illustrated in the example in FIG. 3 indicates that “memory use rate” indicated by overview data generated at 15:03 on Oct. 11, 2012 is an abnormality candidate and “memory use rate” is “60%”.

Further, abnormality candidate types also include “memory use rate rapid rise” and “CPU use rate rapid rise”. In an abnormality state corresponding to a memory use rate rapid rise, a current memory use rate rises to a predetermined rate or more compared to a past memory use rate. That, for example, the memory use rate rises 25% compared to a state one minute before corresponds to a memory use rate rapid rise. In an abnormality state corresponding to a CPU use rate rapid rise, a current CPU use rate rises to a predetermined rate or more compared to a past CPU use rate. That, for example, the CPU use rate rises 25% compared to a state one minute before corresponds to a CPU use rate rapid rise.

An operation which causes abnormality is usually executed when the use rate rapidly rises rather than when a value of the memory use rate or the CPU use rate is high.

Back to explanation of FIG. 1, the transmitting unit 10c transmits overview data to the center 8 every time overview data is generated. Meanwhile, when incident data matching overview data is generated, the transmitting unit 10c transmits the overview data and the incident data to the center 8.

The center 8 performs various processing according to commands from the console 6, and transmits a processing result to the console 6. The center 8 has a memory unit 11 and a control unit 12.

In the memory unit 11, a first DB (Data Base) 11a, a second DB 11b, a third DB 11c and a fourth DB 11d are stored.

In the first DB 11a, every time the application server 7 transmits overview data, a registering unit 12a described below registers the time registered in the “time” item of the overview data and the user operation identifier registered in the “user operation” item in association. FIG. 4 is a view illustrating an example of a data configuration of the first DB. The first DB 11a illustrated in an example in FIG. 4 includes items of “time” and “user operation”. An example of FIG. 4 illustrates that, in a first record of the first DB 11a, a time of “0:00 on Sep. 1, 2012” and a user operation identifier of “[screen D, button k][screen D, button m]” are associated and registered. In addition, each record of the first DB 11a is also referred to as “overview data” for ease of description. Further, the number of user operation identifiers stored in the “user operation” item is one or plural.

In the second DB 11b, the registering unit 12a registers following data every time the application server 7 transmits incident data. That is, in the second DB 11b, the time registered in the “time” item of incident data, the abnormality candidate type registered in the “abnormality candidate type” item and load information registered in the “load information” item are associated and registered. FIG. 5 is a view illustrating an example of a data configuration of the second DB. The second DB 11b illustrated in an example in FIG. 5 includes items of “time”, “abnormality candidate type” and “load information”. The example in FIG. 5 illustrates that, in, for example, the first record of the second DB 11b, a time of “22:20 on Sep. 20, 2012”, an abnormality candidate type of “memory use rate abnormality” and a memory use rate of “61%” are associated and registered.

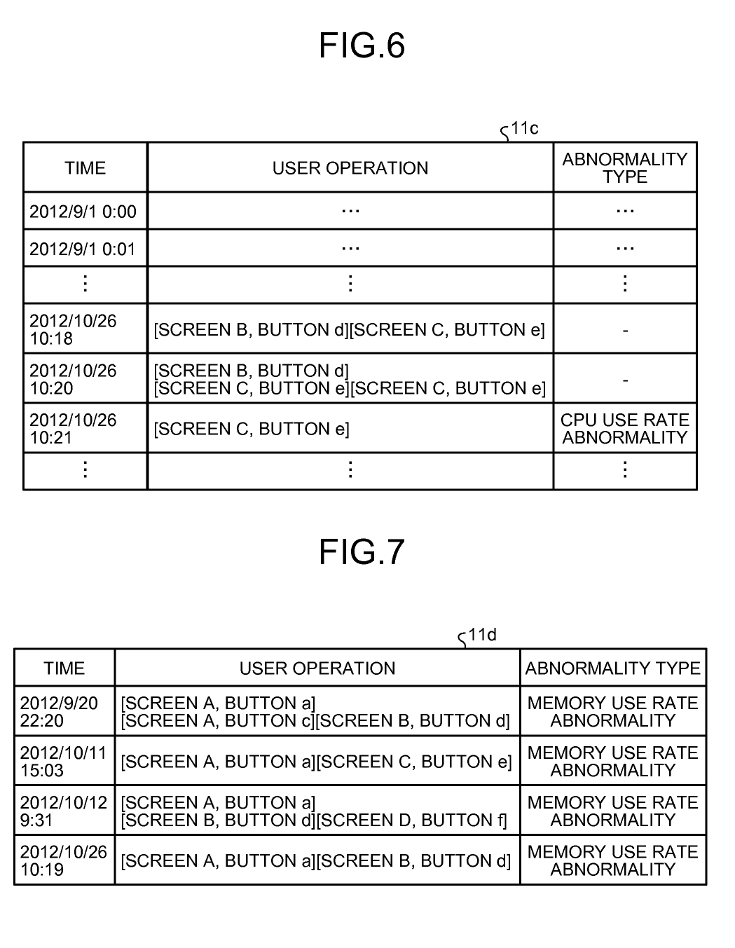

In the third DB 11c, a specifying unit 12c described below registers the following data. That is, in the third DB 11c, a time at which abnormality of a type selected by the specifying unit 12c does not occur in the application server 7 and a user operation identifier which indicates a user operation at this time are associated and registered. In addition to this, in the third DB 11c, an abnormality type which occurs at a time at which the abnormality of the type selected by the specifying unit 12c does not occur and which is an abnormality type other than the abnormality of the type selected by the specifying unit 12c are associated with the time and the user operation identifier, and registered. A state in which the abnormality of the type selected by the specifying unit 12c does not occur in the application server 7 is referred to as a normal state in some cases. FIG. 6 is a view illustrating an example of a data configuration of the third DB. The third DB 11c illustrated in an example in FIG. 6 includes items of “time”, “user operation” and “abnormality type”. Meanwhile, a case will be described below where “memory use rate abnormality” as an abnormality type is selected by the specifying unit 12c described below. The example in FIG. 6 illustrates that, in, for example, records of the third DB 11c, a time of “10:21 on Oct. 26, 2012” in case that the application server 7 is in the normal state”, a following user operation identifier and an abnormality type are associated and registered. That is, the example in FIG. 6 illustrates that the time of “10:21 on Oct. 26, 2012” and a user operation identifier indicating a user operation of “[screen C, button e]” at this time are associated and registered. In addition to this, the example in FIG. 6 illustrates that the abnormality type of “CPU use rate abnormality” is registered in association with the time of “10:21 on Oct. 26, 2012” and a user operation identifier of “[screen C, button e]” at this time. In addition, registration content of the third DB 11c is also referred to as a “whitelist” in some cases.

In the fourth DB 11d, the specifying unit 12c associates and registers a time at which abnormality occurs in the application server 7, a user operation identifier which indicates a user operation at the time at which abnormality occurs in the application server 7 and the type of abnormality which occurs. FIG. 7 is a view illustrating an example of a data configuration of the fourth DB. The fourth DB 11d illustrated in an example in FIG. 7 includes items of “time”, “user operation” and “abnormality type”. The example in FIG. 7 illustrates that, in, for example, records of the fourth DB 11d, a time of “10:19 on Oct. 26, 2012” in case that abnormality occurs in the application server 7, a following user operation identifier and an abnormality type are associated and registered. That is, the example in FIG. 7 illustrates that the time of “10:19 on Oct. 26, 2012”, two user operation identifiers of “[screen A, button a][screen B, button d]” and an abnormality type of “memory use rate abnormality” are associated and registered. In addition, registration content of the fourth DB 11d is also referred to as a blacklist in some cases. Further, in the fourth DB 11d, the specifying unit 12c registers a blacklist per abnormality type. For example, in the fourth DB 11d, four blacklists associated with four abnormality types of “memory use rate abnormality”, “CPU use rate abnormality”, “memory use rate rapid rise” and “CPU use rate rapid rise” are registered.

The memory unit 11 is, for example, a semiconductor memory element such as a flash memory or a memory device such as a hard disk or an optical disk. In addition, the memory unit 11 is not limited to the memory devices of the above type, and may be a RAM (Random Access Memory) and a ROM (Read Only Memory).

The control unit 12 has an internal memory which stores programs which define various processing process and control data, and executes various processing based on these programs and control data. The control unit 12 has the registering unit 12a, an acquiring unit 12b, the specifying unit 12c and an estimating unit 12d.

The registering unit 12a registers various pieces of information in the first DB 11a and the second DB 11b. For example, every time the application server 7 transmits overview data, the registering unit 12a associates and registers the time registered in the “time” item of the overview data and the user operation identifier registered in the “user operation” item in the first DB 11a. Further, the registering unit 12a registers the following data in the second DB 11b every time the application server 7 transmits incident data. That is, in the second DB 11b, the registering unit 12a associates and registers the time registered in the “time” item of incident data, the abnormality candidate type registered in the “abnormality candidate type” item and load information registered in the “load information” item.

The acquiring unit 12b acquires various pieces of information. One aspect of the acquiring unit 12b will be described. When, for example, receiving an abnormality cause estimation processing execution command transmitted from the console 6, the acquiring unit 12b acquires all items of overview data registered in the first DB 11a. For example, all items of overview data registered in the first DB 11a illustrated in the example in FIG. 4 are acquired.

Further, the acquiring unit 12b acquires all items of incident data registered in the second DB 11b. For example, all items of incident data registered in the second DB 11b illustrated in the example in FIG. 5 are acquired.

The specifying unit 12c determines whether or not the application server 7 indicates abnormality, based on load information. When determination indicates abnormality of the application server 7, the specifying unit 12c specifies one or a plurality of functions executed by the application server 7 such as a user operation, and registers the specified function in the blacklist. The function is, for example, a unit of execution of an application, a method or a function executed according to a user operation. Meanwhile, when determination does not indicate abnormality of the application server 7, the specifying unit 12c specifies one or a plurality of functions executed by the application server 7, and registers the specified function in the whitelist.

One aspect of the specifying unit 12c will be described. When the acquiring unit 12b acquires all items of incident data registered in the second DB 11b, the specifying unit 12c determines whether or not there are unselected abnormality candidate types among abnormality candidate types. When there are unselected abnormality candidate types, the specifying unit 12c selects one of unselected abnormality candidate types. For example, when all of four abnormality candidate types of “memory use rate abnormality”, “CPU use rate abnormality”, “memory use rate rapid rise” and “CPU use rate rapid rise” are unselected, the specifying unit 12c selects one of types (for example, “memory use rate abnormality”). Further, the specifying unit 12c specifies all items of incident data including the selected abnormality candidate type from the incident data acquired by the acquiring unit 12b.

Subsequently, the specifying unit 12c determines whether or not there is unselected incident data among the specified incident data. When there is unselected incident data, the specifying unit 12c selects one unselected incident data. When, for example, specifying all items of incident data registered in the second DB lib illustrated in the example in FIG. 5, the specifying unit 12c selects unselected incident data associated with the first record.

Further, the specifying unit 12c determines whether or not the selected incident data indicates abnormality. When, for example, content registered in “abnormality candidate type” of the selected incident data is “memory use rate abnormality”, the specifying unit 12c determines whether or not load information registered in “load information” of the selected incident data is a predetermined threshold or more. Further, when content registered in “abnormality candidate type” of the selected incident data is “CPU use rate abnormality”, the specifying unit 12c determines whether or not load information registered in “load information” of the selected incident data is a predetermined threshold or more. Furthermore, when content registered in “abnormality candidate type” of the selected incident data is “memory use rate rapid rise”, the specifying unit 12c performs the following processing. That is, the specifying unit 12c determines whether or not a memory use rate registered in “load information” of the selected incident data rises to a predetermined rate or more compared to a past memory use rate. Further, when content registered in “abnormality candidate type” of the selected incident data is “CPU use rate rapid rise”, the specifying unit 12c performs the following processing. That is, the specifying unit 12c determines whether or not a CPU use rate registered in “load information” of the selected incident data rises to a predetermined rate or more compared to a past CPU use rate. In addition, a threshold and a predetermined rate used in the specifying unit 12c are higher than a threshold and a predetermined rate used in the extracting unit 10b described above. When, for example, the threshold used upon comparison with a memory use rate in the extracting unit 10b described above is 50%, a threshold used upon comparison with a memory use rate in the specifying unit 12c is 55%. Further, when the threshold used upon comparison with a CPU use rate in the extracting unit 10b described above is 60%, a threshold used upon comparison with a CPU use rate in the specifying unit 12c is 65%. Furthermore, when a predetermined rate used upon comparison with a past memory use rate in the extracting unit 10b described above is 25%, a predetermined rate used upon comparison with a past memory use rate in the specifying unit 12c is 30%. Still further, when a predetermined rate used upon comparison with a past CPU use rate in the extracting unit 10b described above is 25%, a predetermined rate used upon comparison with a past CPU use rate in the specifying unit 12c is 30%. When load information registered in “load information” of the selected incident data is a predetermined threshold or more or rises to a predetermined rate or more, the specifying unit 12c determines that the selected incident data indicates abnormality. Meanwhile, when load information registered in “load information” of the selected incident data is not a predetermined threshold or more or does not rise to a predetermined rate or more, the specifying unit 12c determines that the selected incident data does not indicate abnormality.

When the selected incident data does not indicate abnormality, the specifying unit 12c acquires a user operation identifier registered in the “user operation” item of overview data which includes the time registered in the “time” item of the selected incident data in the “time” item. Further, the specifying unit 12c associates and registers the time registered in the “time” item of the selected incident data, the acquired user operation identifier and the abnormality candidate type registered in the “abnormality candidate type” item of the selected incident data in the third DB 11c. By this means, the time registered in the “time” item of the selected incident data and the acquired user operation identifier are associated and registered in a whitelist. Further, the abnormality candidate type registered in the “abnormality candidate type” item of the selected incident data is associated as an abnormality type with the time and the user operation identifier and registered in the whitelist.

Meanwhile, when the selected incident data indicates abnormality, the specifying unit 12c acquires a user operation identifier registered in the “user operation” item of overview data which includes the time registered in the “time” item of the selected incident data in the “time” item. Further, the specifying unit 12c selects from the fourth DB 11d a blacklist associated with the abnormality candidate type registered in the “abnormality candidate type” item of the selected incident data. Subsequently, the specifying unit 12c associates and registers the time and the abnormality candidate type registered in the “time” and “abnormality candidate type” items of the selected incident data, and the acquired user operation identifier in the selected blacklist. By this means, the time registered in the “time” item of the selected incident data, the acquired user operation identifier and the abnormality type are associated and registered in the blacklist associated with the abnormality candidate type. In addition, the specifying unit 12c registers the abnormality candidate type as an abnormality type in the “abnormality type” item of the blacklist.

Further, the specifying unit 12c specifies all items of data the times of which are registered in the “time” item and are not registered in the whitelists and the blacklists among the overview data acquired by the acquiring unit 12b. Furthermore, the specifying unit 12c associates and registers for each specified overview data the time registered in the “time” item and the user operation identifier registered in the “user operation” item in the third DB 11c. Still further, the specifying unit 12c determines for each specified overview data whether or not there is incident data including the same time as the time registered in the “time” item, and, performs the following processing when there is incident data. That is, the specifying unit 12c acquires an abnormality candidate type registered in “abnormality candidate type” of the incident data including the same time as the time registered in the “time” item. Further, the specifying unit 12c registers the acquired abnormality type candidate in an “abnormality type” item of a corresponding record in the third DB 11c. Furthermore, the specifying unit 12c sorts the records in the third DB 11c in ascending order of times.

Still further, the specifying unit 12c repeats the above processing of determining whether or not there is unselected incident data to the above processing of sorting the records in the third DB 11c in ascending order of times until all items of incident data are not unselected. Thus, the specifying unit 12c can create a blacklist per selected abnormality candidate type.

Subsequently, when all items of incident data are not unselected, the specifying unit 12c performs again processing subsequent to the above processing of determining whether or not there are unselected abnormality candidate types among abnormality candidate types.

Back to explanation of FIG. 1, the estimating unit 12d outputs information of a function among the functions registered in the blacklist by the specifying unit 12c and other than the functions registered in the whitelist by the specifying unit 12c. By this means, the estimating unit 12d can estimate that a function among the functions registered in the blacklist by the specifying unit 12c and other than the functions registered in the whitelist by the specifying unit 12c causes abnormality which occurs in the application server 7.

One aspect of the estimating unit 12d will be described. When the specifying unit 12c determines that there is no unselected abnormality candidate type among abnormality candidate types, the estimating unit 12d performs the following processing. That is, the estimating unit 12d determines whether or not there are unselected abnormality types among abnormality types. When there are abnormality types, the estimating unit 12d selects one of unselected abnormality candidate types. Further, the estimating unit 12d selects a whitelist and a blacklist associated with the selected abnormality type. Meanwhile, the whitelist associated with the selected abnormality type refers to a whitelist from which a record including the selected abnormality type is removed from all records in the third DB 11c. Further, the blacklist associated with the selected abnormality type refers to a blacklist which includes all records the selected abnormality types of which are registered in the “abnormality type” items as described above.

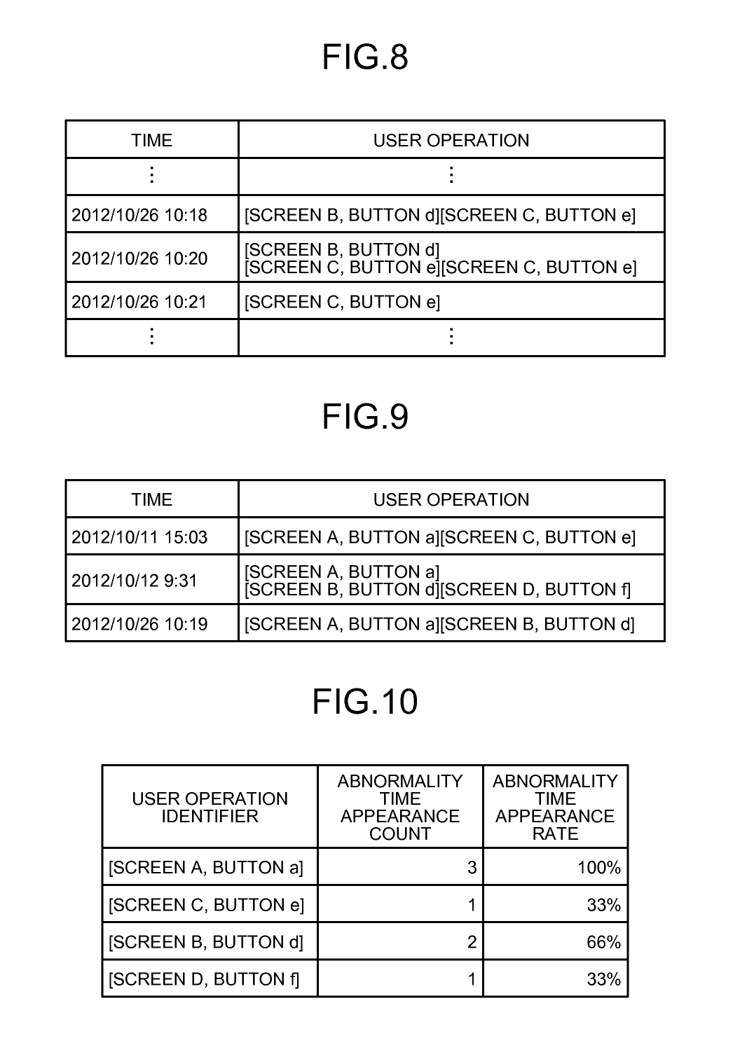

Furthermore, the estimating unit 12d acquires records from the current time to a time which is a certain period of time before the current time among the records registered in the selected whitelist. FIG. 8 is a view for explaining an example of processing executed by the center according to the embodiment. When, for example, the current time is 12:00 on Oct. 31, 2012, a certain period of time is 30 days and registration content of the selected whitelist is content illustrated in FIG. 6 described above, the estimating unit 12d performs the following processing. That is, as illustrated in FIG. 8, the estimating unit 12d acquires records of 30 days from 12:00 on Oct. 31, 2012 to 12:00 on Oct. 1, 2012. In addition, the “abnormality type” item is removed from the records illustrated in an example in FIG. 8.

Subsequently, the estimating unit 12d calculates a normal time appearance count which is the number of times a user operation identifier appears in records per user operation identifier based on the acquired records from the acquired current time to a time which is a certain period of time before the current time. In addition, when a plurality of the same user operation identifiers is included in the same record, the estimating unit 12d calculates a normal time appearance count assuming that the number of user operation identifiers included in this record is “1”. By this means, the estimating unit 12d can calculate the normal time appearance count of the user operation identifier which indicates a user operation when the application server 7 is in the normal state.

Further, the estimating unit 12d acquires records from the current time to a time which is a certain period of time before the current time among the records registered in the selected blacklist. FIG. 9 is a view for explaining an example of processing executed by the center according to the embodiment. When, for example, the current time is 12:00 on Oct. 31, 2012, a certain period of time is 30 days and registration content of the selected blacklist is content illustrated in FIG. 7 described above, the estimating unit 12d performs the following processing. That is, as illustrated in FIG. 9, the estimating unit 12d acquires records of 30 days from 12:00 on Oct. 31, 2012 to 12:00 on Oct. 1, 2012. In addition, the “abnormality type” item is removed from the records illustrated in an example in FIG. 9.

Further, the estimating unit 12d calculates an abnormality time appearance rate per user operation identifier based on the newly acquired records from the current time to a time which is a certain period of time before the current time. An example of a method of calculating an abnormality time appearance rate will be described. The estimating unit 12d calculates an abnormality time appearance count which is the number of times a user operation identifier appears in records per user operation identifier based on the newly acquired records from the current time to a time which is a certain period of time before the current time. In addition, when a plurality of the same user operation identifiers is included in the same record, the estimating unit 12d calculates an abnormality time appearance count assuming that the number of user operation identifiers included in this record is “1”. By this means, the estimating unit 12d can calculate the abnormality time appearance count of the user operation identifier which indicates a user operation when the application server 7 is in an abnormal state. Subsequently, the estimating unit 12d calculates per user operation identifier a rate of an abnormality time appearance count with the number of the newly acquired records from the current time to a time which is a certain period of time before the current time as an abnormality time appearance rate. FIG. 10 is a view for explaining an example of processing executed by the center according to the embodiment. When, for example, the abnormality time appearance count of the user operation identifier of “[screen A, button a]” is “3”, and the number of newly acquired records from the current time to a time which is a certain period of time before the current time is “3”, the estimating unit 12d performs the following processing. That is, as illustrated in FIG. 10, the estimating unit 12d calculates an abnormality time appearance rate “100%” (the abnormality time appearance count is “3”/the number of records is “3”). Further, when the abnormality time appearance count of the user operation identifier of “[screen C, button e]” is “1”, and the number of newly acquired records from the current time to a time which is a certain period of time before the current time is “3”, the estimating unit 12d performs the following processing. That is, as illustrated in FIG. 10, the estimating unit 12d calculates an abnormality time appearance rate “33%” (the abnormality time appearance count is “1”/the number of records is “3”). Further, when the abnormality time appearance count of the user operation identifier of “[screen B, button d]” is “2”, and the number of newly acquired records from the current time to a time which is a certain period of time before the current time is “3”, the estimating unit 12d performs the following processing. That is, as illustrated in FIG. 10, the estimating unit 12d calculates an abnormality time appearance rate “66%” (the abnormality time appearance count is “2”/the number of records is “3”). Further, when the abnormality time appearance count of the user operation identifier of “[screen D, button f]” is “1”, and the number of newly acquired records from the current time to a time which is a certain period of time before the current time is “3”, the estimating unit 12d performs the following processing. That is, as illustrated in FIG. 10, the estimating unit 12d calculates an abnormality time appearance rate “33%” (the abnormality time appearance count is “1”/the number of records is “3”).

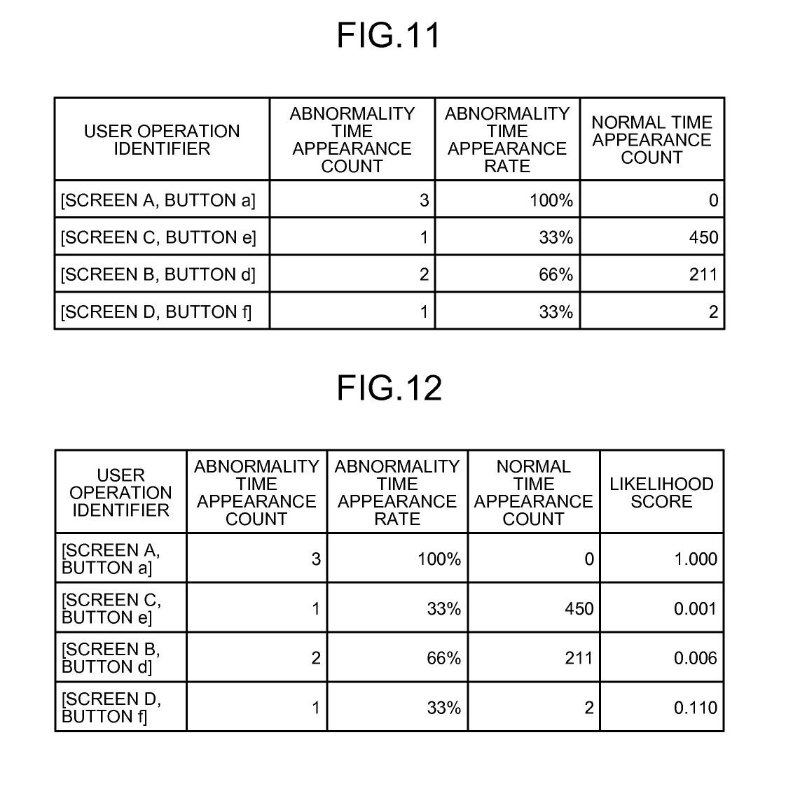

Hereinafter, an abnormality time appearance count, an abnormality time appearance rate and a normal time appearance count of each user operation identifier will be described. FIG. 11 is a view for explaining an example of processing executed by the center according to the embodiment. As illustrated in an example in FIG. 11, an abnormality time appearance count, an abnormality time appearance rate and a normal time appearance count of the user operation identifier of “[screen A, button a]” are “3”, “100%” and “0”. Further, as illustrated in the example in FIG. 11, an abnormality time appearance count, an abnormality time appearance rate and a normal time appearance count of the user operation identifier of “[screen C, button e]” are “1”, “33%” and “450”. Furthermore, as illustrated in the example in FIG. 11, an abnormality time appearance count, an abnormality time appearance rate and a normal time appearance count of the user operation identifier of “[screen B, button d]” are “2”, “66%” and “211”. Still further, as illustrated in the example in FIG. 11, an abnormality time appearance count, an abnormality time appearance rate and a normal time appearance count of the user operation identifier of “[screen D, button flu are “1”, “33%” and “2”.

Further, the estimating unit 12d calculates a likelihood score per user operation identifier. An example of a method of calculating a likelihood score will be described. For example, the estimating unit 12d calculates a likelihood score per user operation identifier according to following equation (1).

Likelihood score=(abnormality time appearance rate)×((abnormality time appearance count)/((abnormality time appearance count)+(normal time appearance count))) (1)

FIG. 12 is a view for explaining an example of processing executed by the center according to the embodiment. When, for example, the abnormality time appearance count, the abnormality time appearance rate and the normal time appearance count of each user operation identifier take the values illustrated in the example in FIG. 11, the estimating unit 12d performs the following processing. That is, as illustrated in FIG. 12d, the estimating unit 12d calculates a likelihood score “1.000” of the user operation identifier of “[screen A, button a]” according to equation (1). That is, as illustrated in FIG. 12d, the estimating unit 12d calculates a likelihood score “0.001” of the user operation identifier of “[screen C, button e]” according to equation (1). That is, as illustrated in FIG. 12d, the estimating unit 12d calculates a likelihood score “0.006” of the user operation identifier of “[screen B, button e]” according to equation (1). Further, as illustrated in FIG. 12, the estimating unit 12d calculates a likelihood score “0.110” of the user operation identifier of “[screen D, button f]” according to equation (1). Meanwhile, the estimating unit 12d may use a user operation identifier associated with the likelihood score which is a predetermined threshold or more in subsequent processing. By this means, the number of processing target user operation identifiers are narrowed down, so that a processing speed increases.

Further, the estimating unit 12d specifies records the likelihood scores of which are a predetermined value or more. For example, the estimating unit 12d specifies user operation identifiers the likelihood scores of which are a predetermined value or more, and specifies records which have the specified user operation identifiers from the third DB 11c and the fourth DB 11d. When, for example, the predetermined value is “0.100”, the estimating unit 12d specifies the user operation identifiers “[screen A, button a]” and “[screen D, button f]” the likelihood scores of which are “0.100” or more. Further, the estimating unit 12d specifies a record which includes the user operation identifier “[screen A, button a]” from the third DB 11c and the fourth DB 11d. Furthermore, the estimating unit 12d specifies a record which includes the user operation identifier “[screen D, button f]” from the third DB 11c and the fourth DB 11d.

Still further, the estimating unit 12d repeats the above processing of determining whether or not there are unselected abnormality types among abnormality types to the above processing of specifying records likelihood scores of which are a predetermined value or more until all abnormality types are not unselected.

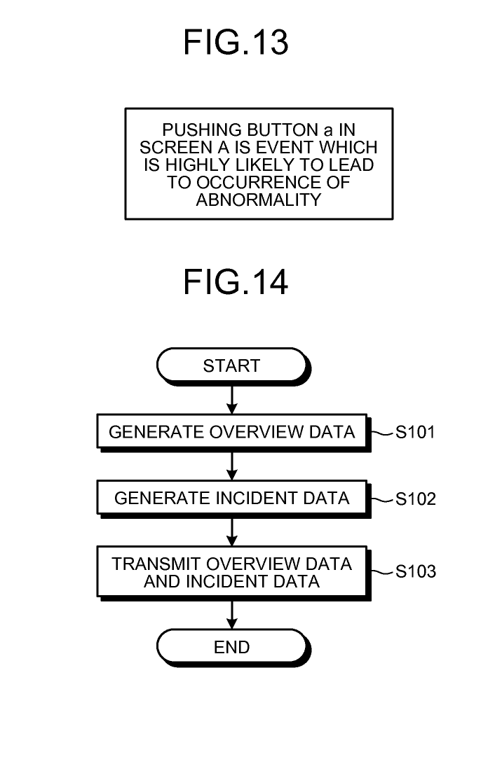

Meanwhile, when there is not unselected abnormality type among abnormality types, the estimating unit 12d generates an image based on the specified record. FIG. 13 is a view for explaining an example of processing executed by the center according to the embodiment. When, for example, record which includes the user operation identifier of “[screen A, button a]” and a record which includes “[screen D, button flu are specified, the estimating unit 12d generates the following image using a predetermined template. For example, the estimating unit 12d generates an image including a message that “Pushing the button a in the screen A is an event which is highly likely to lead to occurrence of abnormality” as illustrated in FIG. 13. In this case, the estimating unit 12d can also generate an image including a message that “Pushing the button f in the screen D is an event which is highly likely to lead to occurrence of abnormality”. Further, the estimating unit 12d can also generate an image including a message that “Pushing the button a in the screen A is an event which is highly likely to lead to occurrence of abnormality. Moreover, pushing the button f in the screen D is an event which is highly likely to lead to occurrence of abnormality”. Furthermore, when there is a function which is highly likely to cause a plurality of abnormality, the estimating unit 12d can also display several top functions which are likely to cause abnormality.

Subsequently, the estimating unit 12d transmits the generated image to the console 6. By this means, the console 6 displays the image.

Next, a flow of processing executed by the agent 10 according to the present embodiment will be described. FIG. 14 is a flowchart illustrating process of generation processing according to the embodiment. This generation processing is repeatedly executed at predetermined time intervals such as one minute intervals.

As illustrated in FIG. 14, the generating unit 10a generates overview data (step S101). Further, the extracting unit 10b extracts overview data which indicates a predetermined event among the generated overview data (step S102). Further, the transmitting unit 10c transmits the overview data, or the overview data and incident data to the center 8 (step S103), and finishes processing.

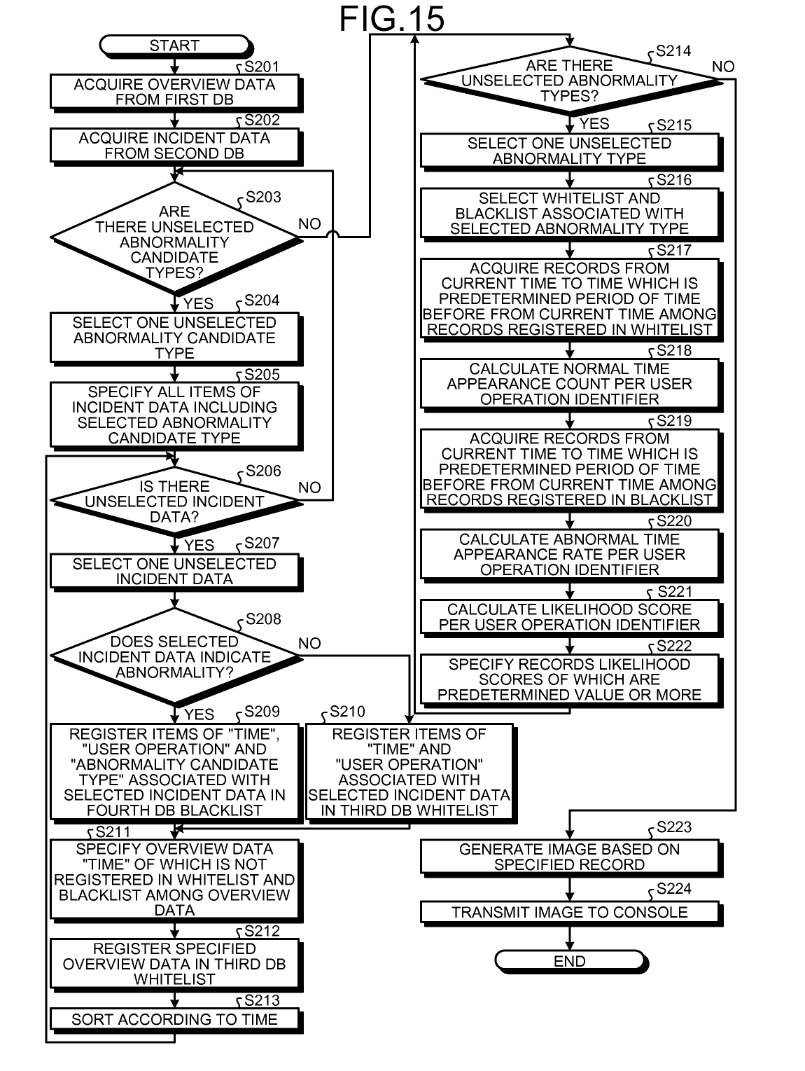

Next, a flow of processing executed by the center 8 according to the present embodiment will be described. FIG. 15 is a flowchart illustrating process of abnormality cause estimation processing according to the embodiment. This abnormality cause estimation processing is executed by the center 8 when, for example, the console 6 inputs a command to execute the abnormality cause estimation processing.

As illustrated in FIG. 15, the acquiring unit 12b acquires all items of overview data registered in the first DB 11a (step S201). Further, the acquiring unit 12b acquires all items of incident data registered in the second DB 11b (step S202). Subsequently, the specifying unit 12c determines whether or not there are unselected abnormality candidate types among abnormality types (step S203). When there are unselected abnormality candidate types (Yes in step S203), the specifying unit 12c selects one of unselected abnormality candidate types (step S204). Further, the specifying unit 12c specifies all items of incident data including the selected abnormality candidate type from the incident data acquired by the acquiring unit 12b (step S205).

Subsequently, the specifying unit 12c determines whether or not there is unselected incident data among the specified incident data (step S206). When there is unselected incident data (Yes in step S206), the specifying unit 12c selects one unselected incident data (step S207).

Further, the specifying unit 12c determines whether or not the selected incident data indicates abnormality (step S208). When the selected incident data does not indicate abnormality (No in step S208), the specifying unit 12c acquires a user operation identifier registered in the “user operation” item of overview data which includes the time registered in the “time” item of the selected incident data in the “time” item. Further, the specifying unit 12c associates and registers the time and the abnormality candidate type registered in the “time” and “abnormality candidate type” items of the selected incident data, and the acquired user operation identifier in the third DB 11c (step S210).

Meanwhile, when the selected incident data indicates abnormality (Yes in step S208), the specifying unit 12c performs the following processing. That is, the specifying unit 12c acquires a user operation identifier registered in the “user operation” item of overview data which includes the time registered in the “time” item of the selected incident data in the “time” item. Further, the specifying unit 12c selects from the fourth DB 11d a blacklist associated with the abnormality candidate type registered in the “abnormality candidate type” item of the selected incident data. Subsequently, the specifying unit 12c associates and registers the time and the abnormality candidate type registered in the “time” and “abnormality candidate type” items of the selected incident data, and the acquired user operation identifier in the selected blacklist (step S209).

Further, the specifying unit 12c specifies all items of data the times of which are registered in the “time” item and are not registered in the whitelists and the blacklists among the overview data acquired by the acquiring unit 12b (step S211). Furthermore, the specifying unit 12c associates and registers for each specified overview data the time registered in the “time” item and the user operation identifier registered in the “user operation” item in the third DB 11c. Still further, the specifying unit 12c determines for each specified overview data whether or not there is incident data including the same time as the time registered in the “time” item, and, performs the following processing when there is incident data. That is, the specifying unit 12c acquires an abnormality candidate type registered in “abnormality candidate type” of the incident data including the same time as the time registered in the “time” item. Further, the specifying unit 12c registers the acquired abnormality type candidate in an “abnormality type” item of a corresponding record in the third DB 11c (step S212). Furthermore, the specifying unit 12c sorts the records in the third DB 11c in ascending order of times (step S213), and returns to step S206.

Meanwhile, when there is no unselected incident data (No in step S206), the specifying unit 12c returns to step S203. Further, when there is not unselected abnormality candidate type (No in step S203), the estimating unit 12d determines whether or not there are unselected abnormality types among abnormality types (step S214). When there are abnormality types (Yes in step S214), the specifying unit 12c selects one of unselected abnormality candidate types (step S215). Further, the estimating unit 12d selects a whitelist and a blacklist associated with the selected abnormality type (step S216).

Subsequently, the estimating unit 12d acquires records from the current time to a time which is a certain period of time before the current time among the records registered in the selected whitelist (step S217).

Subsequently, the estimating unit 12d calculates a normal time appearance count which is the number of times a user operation identifier appears in records per user operation identifier based on the acquired records from the current time to a time which is a certain period of time before the current time (step S218). Next, the estimating unit 12d acquires records from the current time to a time which is a certain period of time before the current time among the records registered in the selected blacklist (step S219).

Further, the estimating unit 12d calculates an abnormality time appearance rate per user operation identifier based on the newly acquired records from the current time to a time which is a certain period of time before the current time (step S220). Furthermore, the estimating unit 12d calculates a likelihood score per user operation identifier (step S221). Subsequently, the estimating unit 12d specifies records the likelihood scores of which are a predetermined value or more (step S222), and returns to step S214.

Meanwhile, when there is not unselected abnormality type (No in step S214), the estimating unit 12d generates an image based on the specified record (step S223). Subsequently, the estimating unit 12d transmits the generated image to the console 6 (step S224), and finishes processing.

As described above, the center 8 according to the present embodiment acquires load information of the application server 7. Further, the center 8 determines whether or not the application server 7 indicates abnormality, based on load information. When determination indicates abnormality of the application server 7, the center 8 specifies one or a plurality of functions executed by the application server 7, and registers the specified function in the blacklist. Meanwhile, when determination does not indicate abnormality of the application server 7, the center 8 specifies one or a plurality of functions executed by the application server 7, and registers the specified function in the whitelist. Subsequently, the center 8 outputs information of a function among the functions registered in the blacklist and other than the functions registered in the whitelist. Consequently, according to the present embodiment, it is possible to estimate an event which is highly likely to lead to occurrence of abnormality.

Although the embodiment related to the disclosed apparatus has been described, the present invention may be implemented in various modes in addition to the above embodiment. Hence, another embodiment incorporated in the present invention will be described.

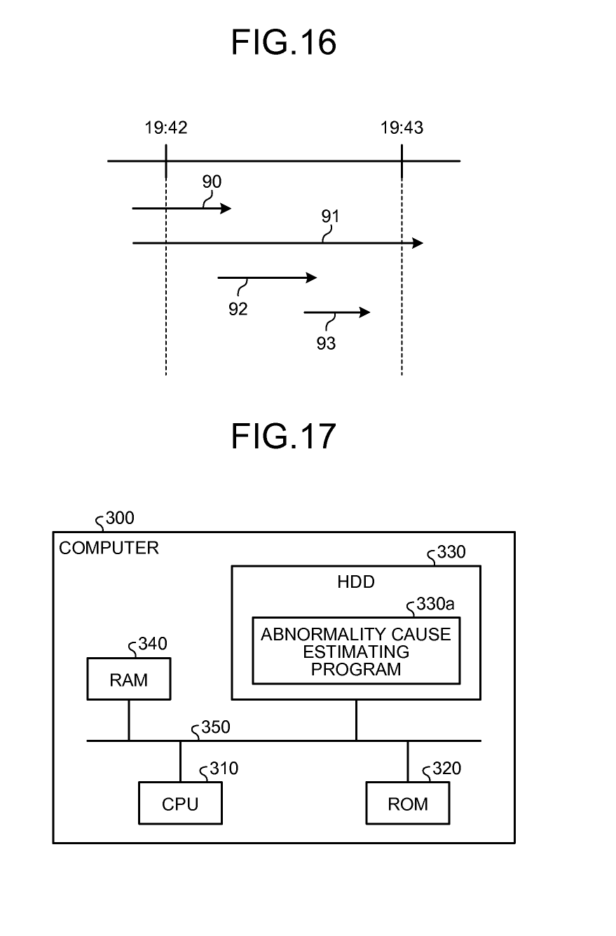

For example, as illustrated in FIG. 16, the generating unit 10a can also acquire information 90 and 91 crossing a generation timing (which is 19:42 in the figure) among information 90 to 93 of the past one minute as to a button operated by the user. Thus, by acquiring load information at a plurality of timings spaced predetermined time intervals apart, a data size of overview data becomes small, and a processing speed of abnormality cause estimation processing using overview data increases.

Further, in the above embodiment, when, for example, receiving an abnormality cause estimation processing execution command transmitted from the console 6, the acquiring unit 12b acquires all items of overview data registered in the first DB 11a. However, the acquiring unit 12b may execute processing of acquiring overview data not only at a timing specified by a console but also on a regular basis (for example, an interval such as once in ten minutes). As a result, a system administrator can acquire abnormality occurrence information without operating the console when abnormality occurs in the system.

When, for example, the abnormality cause estimating apparatus detects that the memory use rate in the system rapidly rises by acquiring overview data on a regular basis, it is possible to notify that occurrence of abnormality which is a rapid rise of a memory resource rate and a user operation identifier of a high likelihood score to the administrator by means of a mail.

Further, entirety or part of processing which is automatically performed of each processing described in the embodiment may be manually performed. Furthermore, entirety or part of processing which is manually performed of each processing described in the embodiment may be automatically performed by a known method.

Still further, according to various loads or a use status, processing in each step of each processing described in the embodiment may be divided at random or combined. Moreover, steps can be skipped.

Further, according to various loads or a use status, an order of processing in each step of each processing described in the embodiment can be changed.

Furthermore, each component of each illustrated apparatus is functionally conceptual, and need not to be physically configured. That is, a specific state of dispersion and integration of each apparatus is not limited to the illustrated state, and entirety or part thereof can be configured by being functionally or physically dispersed and integrated in random units according to various loads or a use status.

[Abnormality Cause Estimating Program]

Further, various processing of the center 8 which is an example of the abnormality cause estimating apparatus described in the above embodiment can be realized by causing a computer system such as a personal computer or a work station to execute a program prepared in advance. Hereinafter, an example of a computer which executes a program which has the same function as that of the center 8 described in the above example will be described using FIG. 17. FIG. 17 is a view illustrating a computer which executes an abnormality cause estimating program.

As illustrated in FIG. 17, a computer 300 has a CPU 310, a ROM 320, a Hard Disk Drive (HDD) 330 and a RAM 340. These components 310 to 340 are connected through a bus 350.

A basic program such as an OS is stored in the ROM 320. Further, in the HDD 330, an abnormality cause estimating program 330a which exhibits the same functions as those of the registering unit 12a, the acquiring unit 12b, the specifying unit 12c and the estimating unit 12d described in the above embodiment are stored in advance. In addition, the abnormality cause estimating program 330a may be adequately separated.

Further, the CPU 310 reads the abnormality cause estimating program 330a from the HDD 330 to execute.

In addition, the above abnormality cause estimating program 330a does not need to be stored in the HDD 330 from the beginning.

For example, the abnormality cause estimating program 330a is stored in a “portable physical medium” such as a flexible disk (FD), a CD-ROM, a DVD disk, a magnetooptic disc or an ID card inserted in the computer 300. Further, the computer 300 may read the abnormality cause estimating program 330a from these media to execute.

Furthermore, the abnormality cause estimating program 330a is stored in, for example, “another computer (or a server)” connected to the computer 300 through a public line, the Internet, a LAN or a WAN. Still further, the computer 300 may read the abnormality cause estimating program 330a from these media to execute.

It is possible to estimate an event which is highly likely to lead to occurrence of abnormality.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
acquiring load information of a system;
determining whether or not the system indicates abnormality based on the load information, and specifying a first function group which includes one or a plurality of functions executed by the system when the determination indicates that the system indicates the abnormality and specifying a second function group which includes one or a plurality of functions executed by the system when the determination indicates that the system does not indicate abnormality; and
outputting information of a function which is not included in the second function group among the functions included in the first function group.

2. The non-transitory computer-readable recording medium according to claim 1, wherein the function group is acquired at a plurality of times which is spaced a predetermined interval apart.

3. The non-transitory computer-readable recording medium according to claim 1, wherein the specifying the first function group specifies the first function group when a data size stored in a memory unit of the system is a first predetermined value or more and when a use rate of a calculation processing unit of the system is second predetermined value or more.

4. An abnormality cause estimating apparatus, comprising:
a memory; and
a processor coupled to the memory, wherein the processor executes a process including:
acquiring load information of a system;
specifying a first function group which includes one or a plurality of functions executed by the system when the system indicates the abnormality, based on the load information and specifying a second function group which includes one or a plurality of functions executed by the system when the system does not indicate abnormality; and
outputting information of a function which is not included in the second function group among the functions included in the first function group.

5. An abnormality cause estimating method executed by a computer, the abnormality cause estimating method comprising:
acquiring load information of a system, using a processor;
determining whether or not the system indicates abnormality based on the load information, and specifying a first function group which includes one or a plurality of functions executed by the system when the determination indicates that the system indicates the abnormality and specifying a second function group which includes one or a plurality of functions executed by the system when the determination indicates that the system does not indicate abnormality, using the processor; and
outputting information of a function which is not included in the second function group among the functions included in the first function group, using the processor.
